(19) United States
(12) Patent Application Publication
(10) Pub. No.: US 2017/0235038 A1
(43) Pub. Date: Aug. 17, 2017

(54) BACKLIGHT MODULE AND ITS REFLECTIVE LAYER

(71) Applicant: Shenzhen China Star Optoelectronics Technology Co. Ltd., Shenzhen, Guangdong (CN)

(72) Inventor: Yong FAN, Shenzhen, Guangdong (CN)

(73) Assignee: Shenzhen China Star Optoelectronics Technology Co. Ltd., Shenzhen, Guangdong (CN)

(21) Appl. No.: 14/907,330

(22) PCT Filed: Dec. 25, 2015
(86) PCT No.: PCT/CN2015/099025

§ 371 Date: Jan. 25, 2016

(30) Foreign Application Priority Data
Nov. 24, 2015 (CN) 201510831291.3

(51) Int. Cl. F21V 8/00; G02B 1/14

(52) U.S. Cl. CPC G02B 6/0055; G02B 6/0035; G02B 1/14; G02B 6/0065

(57) ABSTRACT

The present invention discloses a reflective layer, including a plurality of first medium membrane and a plurality of second medium membrane, wherein the plurality of first medium membrane and the plurality of second medium membrane are alternately stacked, and reflectivity of the first medium membrane is larger than the second medium membrane. The present invention also discloses a backlight module, including a light guide plate, a light source, and a reflective layer. The material of the light guide plate in the present invention is glass with a higher hardness and no additional back plate is needed to support the backlight module to meet the requirement of saving the energy loss of the backlight and to meet the needs of thinness. The reflective layer is formed by stacking plurality of medium membrane with different reflectivity to greatly raise the reflectivity.

### BACKGROUND OF THE INVENTION

1. Field of the Invention

The present invention relates to a display technology field, and more particularly to a backlight module and its reflective layer.

2. Description of the Prior Art

Backlight module is one of the key components of the liquid crystal display, the liquid crystal itself does not illuminated, the function of the backlight module is to adequate supply of brightness and uniform distribution of light, so that it can display the image properly. Currently, two commonly used backlight module are direct type backlight module and edge type backlight module. The essential difference between the two type is where the site of the light source. The light source of the direct type backlight module is located below the display panel, while the light source of the edge type backlight module is located in the edge of the backlight plate. Since the light source of the direct type backlight module is located below the display panel, the thickness of the display by the additional present of the light source. So, in order to meet the needs of thin liquid crystal display, the edge type backlight module has been more widely used.

The edge type backlight module includes a reflective plate, a light source and a light guide plate, and the light source is in the edge of the light guide plate. The material of the conventional light guide plate is polymethyl methacrylate (PMMA), or polyacrylate organic-inorganic nanocomposites (MS). Since the hardness of light guide plate made by these materials is lower, the metal plate is further needed to support the backlight module. The additional component of the liquid crystal display is needed, and the thickness of the entire liquid crystal display is increased, it does not meet the needs of thinning.

### SUMMARY OF THE INVENTION

A backlight module without a back plate is provided in the present invention to solve the insufficient of the conventional technology. The backlight module can save the energy loss, meet the requirement of thickness, and raise the reflectivity and improve the reliability and scratch resistance.

A reflective layer is provided in the present invention, including a plurality of first medium membrane and a plurality of second medium membrane, wherein the plurality of first medium membrane and the plurality of second medium membrane are alternately stacked, and reflectivity of the first medium membrane is larger than the second medium membrane.

Further, the number of the layers of the first medium membrane and the second medium membrane is 15-50 respectively.

Further, reflective layer further including a protective layer and the protective layer formed on the surface of the first medium membrane on the upmost bottom layer.

Further, the material of the first medium membrane with high reflectivity is TiO₂, ZnS or SiN, and the material of the second medium membrane with lower reflectivity is SiO₂ or MgF₂.

A backlight module is also provided in the present invention including a light guide plate, wherein the light guide plate comprising a light incident surface, a light extraction surface vertical to the light incident surface, and a bottom surface opposite to the light extraction surface; a light source, wherein the light source is formed corresponding to the light incident surface; and a reflective layer, wherein the reflective layer formed on the bottom surface away from the light incident surface, wherein the reflective layer including a plurality of first medium membrane and a plurality of second medium membrane, wherein the plurality of first medium membrane and the plurality of second medium membrane are alternately stacked, and reflectivity of the first medium membrane is larger than the second medium membrane.

Further, the number of the layers of the first medium membrane and the second medium membrane is 15-50 respectively.

Further, reflective layer further including a protective layer and the protective layer formed on the surface of the first medium membrane on the upmost bottom layer.

Further, the material of the first medium membrane with high reflectivity is TiO₂, ZnS or SiN, and the material of the second medium membrane with lower reflectivity is SiO₂ or MgF₂.

Further, a plurality of the scattering branch formed on the light incident surface.

Further, the material of the light guide plate is glass.

The material of the light guide plate of the backlight module of the present invention is glass, with a higher hardness and no additional back plate is needed to support the backlight module to meet the requirement of saving the energy loss of the backlight and to meet the needs of thinness. The reflective layer is formed by stacking plurality of medium membrane with different reflectivity to greatly raise the reflectivity and increase the light extraction efficiency of the backlight module, improve the reliability and scratch resistance, while due to the high reflectivity of the reflective layer, the back side of the backlight module can also serve as a mirror to achieve the purpose of a multi-purpose display panel.

### BRIEF DESCRIPTION OF THE DRAWINGS

In order to more clearly illustrate the embodiments of the present invention or prior art, the following figures will be described in the embodiments are briefly introduced. It is obvious that the drawings are merely some embodiments of the present invention, those of ordinary skill in this field can obtain other figures according to these figures without paying the premise.

FIG. 1 illustrates the structure of the display according to the present invention.

### DETAILED DESCRIPTION OF PREFERRED EMBODIMENTS

Embodiments of the present invention are described in detail with the technical matters, structural features, achieved objects, and effects with reference to the accompanying drawings as follows. It is clear that the described embodiments are part of embodiments of the present invention, but not all embodiments. Based on the embodiments of the present invention, all other embodiments to those of ordinary skill in the premise of no creative efforts obtained, should be considered within the scope of protection of the present invention.

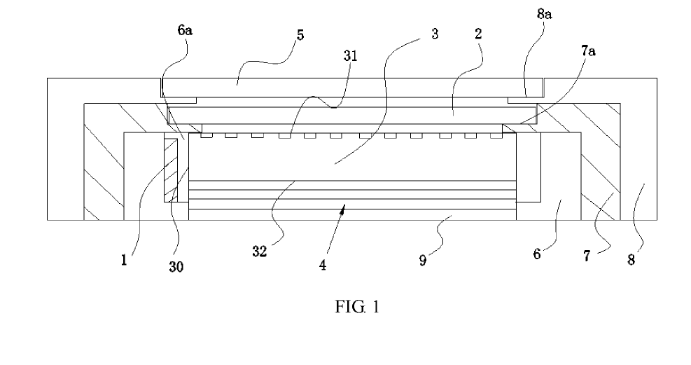

Referring to FIG. 1, FIG. 1 illustrates the structure of the display according to the present invention including a backlight module and a display panel 5 on the backlight module.

The backlight module of this embodiment includes a light source 1, an optical film 2, a light guide plate 3 and a reflective layer 4 from top stacked subsequently. That is, the light guide plate is between the optical film and the reflective layer. The display panel is on the optical film. Specifically, the display further includes a back frame 6 to fix the backlight module. The back frame toward the open side of the light guide plate has a groove 6a for placing the light source; a middle frame 7 is provided in the outer side of the back frame to fix the back frame and the optical film, an opening 7a is formed in the middle frame 7 for placing the optical film; in addition, a front frame 8 is provided in the outer side of the middle frame for fixing the middle frame and the display panel, and an opening 8a is formed on the front frame for placing the display panel.

Specifically, the light guide plate 3 includes a light incident surface 30, and a light extracting surface 31 vertical to the light incident surface, that is, the light guide plate 3 is contacting to the optical film 2. A bottom surface 32 opposite to the light extracting surface 31, the bottom surface 32 is the surface that the light guide plate 3 contacts the reflective layer 4. And the light source 1 is set corresponding to the light incident surface 30. In order to increase the light transmitting efficiency inside the light guide plate, one side of the light extracting surface towards to the bottom surface has a scattering branch. The light from the light source 1 get into the light guide plate 3 from the light incident surface 30, scatter the light to each direction by the scattering branch and the light uniform extracted from the light extracting surface, wherein a part of the light will be incident to the bottom surface 32. In order to avoid the light be extracted from the bottom surface such as light leakage, a reflective layer 4 is formed in the bottom surface. When the light incident to the bottom surface, the light will be reflected by the reflective layer 4 to the light guide plate 3 and increase the efficiency of the backlight module.

In the embodiment of the present invention, the material of the light guide plate is glass instead of the conventional material of polymethyl methacrylate (PMMA), or polyacrylate organic-inorganic nanocomposites (MS). Because the hardness of the glass is larger than the material of polymethyl methacrylate (PMMA), or polyacrylate organic-inorganic nanocomposites (MS). A back plate will not be needed to support the backlight module, if glass is chosen as the material of the light guide plate, the optical film, and the reflective is adhered on the light guide plate and formed a backlight module, and backlight module can be supported by the light guide plate to meet the requirement of saving the energy loss of the backlight and to meet the needs of thinness. So the back frame does not include a back plate under the reflective layer, the corresponding, the middle frame and the front frame is not including any back plate.

In order to increase the reflecting efficiency, the reflective layer 4 is formed and stacked by a plurality of medium membrane with different reflectivity. In this embodiment, the reflective layer at least includes a plurality of first medium membrane and a plurality of second medium membrane, wherein the plurality of first medium membrane and the plurality of second medium membrane are alternately stacked or alternately set near the bottom surface 32. The reflectivity of the first medium membrane is larger than the second medium membrane. Wherein the material of the first medium membrane with high reflectivity is TiO₂, ZnS or SiN. The material of the second medium membrane with lower reflectivity is SiO₂ or MgF₂. The number of the layers of the medium membrane can be adjusted by the real need. For example, in this embodiment, the number of the layers of the first medium membrane is 30, and the number of the layers of the second medium membrane is 30 to form a 60 layers' medium membrane. In other embodiment, the number of the layers of the first medium membrane and the second medium membrane is 15-50 respectively to meet the requirement of present invention. The thickness of the medium membrane is adjusted according to the wavelength of the incident light and the reflectivity of the medium membrane. In a preferred embodiment, the thickness of the medium membrane is ¼ wavelength of the incident light divided by the reflectivity of the medium membrane. Comparing to the conventional metal medium reflective layer, the reflective layer in this embodiment does not absolve by the metal and by the increasing of the number of the layers of the medium membrane, the reflective efficiency of the medium membrane is increasing, and can reach the 100% reflectivity result.

In order to avoid the damage of the medium membrane away from the bottom surface, a SiO₂ protective layer 9 with ½ wavelength is deposited on the medium membrane away from the bottom surface to protect the medium membrane. Since the medium membrane is coated on the bottom surface of the light guide plate, the scattering branch is formed on the light incident surface in order to increase the adhesive of the medium membrane and the light guide plate.

In this embodiment, the reflective layer is as a back side of the backlight module. It can be used as a mirror on the back side of the backlight module due to its high reflectivity, and achieve the goal of a multi-function display panel.

Above are embodiments of the present invention, which does not limit the scope of the present invention. Any modifications, equivalent replacements or improvements within the spirit and principles of the embodiment described above should be covered by the protected scope of the invention.

What is claimed is:

1. A reflective layer, comprising a plurality of first medium membrane and a plurality of second medium membrane, wherein the plurality of first medium membrane and the plurality of second medium membrane are alternately stacked, and reflectivity of the first medium membrane is larger than the second medium membrane.

2. The reflective layer according to claim 1, wherein the number of the layers of the first medium membrane and the second medium membrane is 15-50 respectively.

3. The reflective layer according to claim 1, further comprising a protective layer and the protective layer formed on the surface of the first medium membrane on the upmost bottom layer.

4. The reflective layer according to claim 1, wherein the material of the first medium membrane with high reflectivity is TiO2, ZnS or SiN, and the material of the second medium membrane with lower reflectivity is SiO2 or MgF2.

5. A backlight module, comprising:
a light guide plate, wherein the light guide plate comprising a light incident surface, a light extraction surface vertical to the light incident surface, and a bottom surface opposite to the light extraction surface;
a light source, wherein the light source is formed corresponding to the light incident surface; and
a reflective layer, wherein the reflective layer formed on the bottom surface away from the light incident surface, wherein the reflective layer including a plurality of first medium membrane and a plurality of second medium membrane, wherein the plurality of first medium membrane and the plurality of second medium membrane are alternately stacked, and reflectivity of the first medium membrane is larger than the second medium membrane.

6. The backlight module according to claim 5, wherein the number of the layers of the first medium membrane and the second medium membrane is 15-50 respectively.

7. The backlight module according to claim 5, further comprising a protective layer and the protective layer formed on the surface of the first medium membrane on the upmost bottom layer.

8. The backlight module according to claim 5, wherein the material of the first medium membrane with high reflectivity is TiO₂, ZnS or SiN, and the material of the second medium membrane with lower reflectivity is SiO₂ or MgF₂.

9. The backlight module according to claim 5, further comprising a plurality of the scattering branch formed on the light incident surface.

10. The backlight module according to claim 5, wherein the material of the light guide plate is glass.

11. The backlight module according to claim 6, wherein the material of the light guide plate is glass.

12. The backlight module according to claim 7, wherein the material of the light guide plate is glass.

13. The backlight module according to claim 8, wherein the material of the light guide plate is glass.

14. The backlight module according to claim 9, wherein the material of the light guide plate is glass.
